(19) United States
(12) Patent Application Publication
(10) Pub. No.: US 2012/0118183 A1
(43) Pub. Date: May 17, 2012

(54) ROLLER ROTARY OFFSET PRINTING PRESS HAVING AT LEAST ONE COATING UNIT WITH A CHAMBER BLADE AND AN ANILOX ROLLER

(75) Inventors: Bernd Kurt Masuch, Kurmach (DE); Wolfgang Otto Reder, Veitshochheim (DE)

(73) Assignee: KOENIG & BAUER AKTIENGESELLSCHAFT, Wuzburg (DE)

(21) Appl. No.: 13/263,090

(22) PCT Filed: Mar. 29, 2010
(86) PCT No.: PCT/EP10/54077

§ 371 Date: Oct. 17, 2011

(30) Foreign Application Priority Data
Apr. 6, 2009 (DE) 10 2009 002 228.7

(51) Int. Cl. B41F 3/34

(52) U.S. Cl. 101/217; 101/492

(57) ABSTRACT

A roller rotary offset printing press has at least one coating unit and at least one printing unit. The coating unit comprises at least one coating unit and at least one printing unit. The coating unit comprises at least one chamber blade having a water-based coating and at least one anilox roller. The coating unit is arranged along a transport path of a print stock downstream of the at least one printing unit of the roller rotary offset printing press. At least one pair of two rollers is arranged that together form a coating gap. At least one roller of the at least one pair is in contact with the at least one anilox roller. The conveyed volume, at least on one part of the shell surface of the at least one anilox roller, is filled by an amount of coating, the mass of which, based on this part of the shell surface of the at least one anilox roller, minus a water portion, equals, on average, a maximum of 4 g/m². A blanket having several layers can be placed or is placed on at least one roller of the coating unit.

### CROSS-REFERENCE TO RELATED APPLICATIONS

This application is the U.S. National Phase, under 35 USC 371, of PCT/EP2010/054077, filed Mar. 29, 2010; published as WO 2010/127913 A1 on Nov. 11, 2010 and claiming priority to DE 10 2009 002 228.7, filed Apr. 6, 2009, the disclosures of which are expressly incorporated herein by reference.

### FIELD OF THE INVENTION

The invention relates to methods for using a web-fed rotary printing press, and to a web-fed rotary offset printing press having at least one coating unit and at least one printing couple.

The printing press has at least one coating unit and at least one printing couple. The coating unit includes at least one chamber doctor blade containing a water-based varnish and at least one anilox roller which has a plurality of depressions in its outer surface that together form a clip volume. The coating unit is disposed downstream of the at least one printing couple of the web-fed rotary printing press along a transport route of a print substrate which is processed by the web-fed rotary printing press and by the coating unit. At least one pair of two rollers is provided and form a coating gap.

### BACKGROUND OF THE INVENTION

In the production of printed products, it is a known process to coat these printed products with a layer of varnish. This process serves a protective purpose in that ink that has been applied to a print substrate in a previous step is thereby fixed, and any bleeding or smearing of the ink, for example, onto parts of the printing press, onto other printed products, or onto the hands of a person holding the printed products is prevented. In addition, with this process a printed product having a higher quality appearance is produced, since a multitude of different varnishes can be used to create various effects. For example, glossy or matte varnishes can be used, which cover the printed product completely or partially. Also known are scented varnishes, which, when acted on by gentle friction, release fragrance contained in minute capsules, along with varnishes that have a metallic or glitter effect. These varnishes produce a metallic effect by way of a multitude of shiny metallic particles contained in the varnish, while a glitter effect is produced by a multitude of usually larger, for example, iridescent and/or fluorescent particles, contained in the varnish.

Various coating systems are known, for example, systems containing a catalyst which triggers a cross-linking reaction of the substances contained in the varnish. This catalyst can be activated, for example, by means of UV or electron radiation. Other methods require a dryer, which uses infrared radiation or hot air to dry the coating. Such “heatset varnishes” are therefore dried in a manner similar to the process for drying “heatset inks”, which also require a dryer, in which the excess liquid components of the ink are removed by evaporation using hot air, for example. Because the web of print substrate is heated during this process, a device is also ordinarily required for cooling the web of print substrate again. Therefore, the use of such varnishes is relatively costly in terms of the equipment required.

From DE 102 07 184 A1 a printing press is known which does not use “heatset inks” and therefore also does not have a “heatset dryer” or a cooling device. A printing unit for applying a sealer, which is optional in this printing press, is followed by an IR-, a UV-, or an electron beam dryer, which can be equipped with a thermal doctor blade. The volume of varnish that is applied is not specified in detail.

From WO 2007/087531 A2 a method is known, in which a web-type print substrate imprinted in a “coldset” process is coated within a short period of time on both sides with a water-based varnish, which dries by way of the liquid component of the varnish penetrating into the print substrate. The coating process causes no wrinkling of the print substrate, and a smearing of the ink off of the substrate and an adhesion of the printed products to one another are prevented. As a critical parameter for the embodiment of these properties, the volume of varnish applied per unit of surface area of print substrate is specified.

DE 102 06 601 discloses a coating unit of a printing press comprising a trough, which contains a water-based varnish, and an anilox roller, wherein the anilox roller has a plurality of depressions on its outer surface which together form a dip volume, and wherein the coating unit is disposed downstream of a printing couple of the printing press, along a transport route of a print substrate that is processed by the printing press and by the coating unit, wherein, along the transport route of the print substrate, downstream of the coating unit, apart from guide rollers or other devices that modify the direction of transport of the print substrate, a folding apparatus and/or a cutting unit is provided as the next apparatus that acts on the print substrate. An applied coating of varnish is dried by means of a drying device.

EP 0 930 161 B1 discloses a coating unit of a web-fed rotary offset printing press, which comprises at least one chamber doctor blade containing a water-based varnish and at least one anilox roller, wherein at least one anilox roller has a multitude of depressions in its outer surface which together form a dip volume, and wherein the coating unit is disposed downstream of a printing couple of the web-fed rotary offset printing press, along a transport route of a print substrate processed by the web-fed rotary offset printing press and by the coating unit, wherein downstream of the coating unit along the transport route of the print substrate, apart from guide rollers or other devices for modifying the direction of transport of the print substrate, a folding apparatus and/or a cutting unit is provided as the next apparatus that acts on the print substrate. In this case, it is essential that the varnish is applied by the anilox roller acting in an opposite operating direction in relation to the imprinted print substrate.

From U.S. Pat. No. 4,574,732 A, a coating unit is known, with which varnish is transferred, via a smearing process onto a substrate. By the use of pivoting arms, rollers can be pressed against an impression roller. Print substrate is guided through two coating gaps with a horizontal and a vertical component.

### SUMMARY OF THE INVENTION

The problem addressed by the invention is that of devising a method for using a web-fed rotary offset printing press, and a web-fed rotary offset printing press having at least one coating unit and at least one printing couple.

The problem is solved according to the invention by provision of the two rollers, which form a coating gap and which together form a roller pair in such a way that a plane, which contains the rotational axis of one of these two rollers, and which contains a point on a rotational axis on the other of the two rollers and disposed within a volume defined by this other of these two rollers, forms an angle of less than 45° with a horizontal plane. At least one roller of at least one such roller pair is in contact with the at least one anilox roller. The dip volume, over at least a part of the at least one anilox roller, is filed with a volume of varnish, the mass of which, minus a water component, is an average of at most 4 g/m². A packing having a plurality of layers is either mounted, or can be mounted on at least one roller of the coating unit. At least one rotational axis of an anilox roller of the coating unit is positioned higher than all the rotational axes of forme cylinders and other cylinders and rollers which are disposed in a printing unit situated upstream of the coating unit in the direction of transport of the print substrate. The at least one printing couple is separable. One part of the housing of the at least one printing couple is displaceable and one part of the housing of the at least one printing couple is not displaceable. The at least one coating unit is not separable. A housing of the at least one coating unit is rigidly connected to one of the parts of the housing of the at least one printing couple.

The benefits to be achieved by the invention consist particularly in that the printed products treated by the coating unit have several of the advantages over uncoated printed products, such as improved gloss and contrast and greatly diminished smearing behavior, and a high-quality look of the paper, which can typically be achieved with coating devices, although the coating unit is relatively simple in structure, and does not require a dryer downstream. Therefore, costs can be reduced by using more cost-efficient paper.

A further advantage consists in that the risk of inks or varnish on a print substrate becoming smeared is reduced because all contact occurring between involved anilox rollers of the coating unit and/or forme rollers of the coating unit and/or impression cylinders of the coating unit and/or transfer cylinders and/or the print substrate is rolling contact. As a result of this gentle treatment, drying without a dryer is facilitated, since no dryer is even necessary to protect freshly applied inks or varnishes from smearing.

A further advantage consists in positioning the rollers that form a coating gap in such a way that one of the rotational axes thereof and a point contained within the volume of the roller assigned to this other rotational axis lie within a plane that is inclined less than 45° from horizontal, which allows the coating unit to be positioned in a particularly favorable location within a printing press, particularly on a printing unit and/or a printing tower, without thereby inhibiting web guidance and/or configuring said web guidance such that an unnecessarily large number of guide rollers come into contact with a print image prior to coating.

It is further advantageous that, as a result of the elimination of the dryer, not only is less space required, but investment and operating costs, for example, energy and maintenance expenses, can also be decreased.

A further advantage consists in that, due to the relatively small space requirement, already existing printing presses can be retrofitted. For example, the coating unit can be installed in the superstructure of a printing press. The space requirement is also small because no dryer is provided, because the distance between printing couple and coating unit is relatively small, and because the coating unit is relatively simple and compact in structure.

A further advantage consists in the elimination of volatile organic compounds and other, for example, environmentally hazardous substances, such as can be present in varnishes that require drying by UV radiation. A further advantage, therefore, is that no hazardous waste is produced.

A further advantage consists in that the varnish contained in the coating unit is a water-based varnish, which dries so quickly, by penetration, for example, that the coating unit can be disposed for coating in a web-fed rotary offset printing press, without the transport speed of a print substrate being slower than the transport speed for the print substrate that is customary for this printing couple without an active coating unit, or approximately 12-15 m/s. Therefore, there is no disadvantage with respect to speed in relation to coating units that operate with a UV coating system, for example. The transport path downstream of the varnish application is therefore also kept short.

A further advantage consists in that, because a roller that is in contact with an at least partially coated side of the print substrate can be disengaged from said substrate, the print substrate is prevented from becoming stuck to said roller when the print substrate is not moving, particularly when the coating unit and/or the printing press are in emergency shut-off mode. In this case, the direction of a corresponding disengaging movement is chosen such that it can be achieved with the simplest possible construction, in other words, for example, it is a linear movement and/or a pivoting movement with components exclusively in directions perpendicular to the rotational axes of components of the coating unit.

A further advantage consists in that, in conjunction with a preceding imprinting of a print substrate by means of a printing couple with exclusively dry offset inks, the liquid components of the applied varnish penetrate particularly rapidly, thereby further preventing decreases in the print substrate web speed. This advantage results from the circumstance that, until the time at which the varnish is applied, the print substrate does not come into contact with any material containing water, and is therefore still highly absorbent.

A further advantage consists in that, in conjunction with a preceding imprinting with “coldset inks”, a drying apparatus is not required for any of the entire production process of the printed products, and therefore, any disadvantages associated with dryers, such as an unacceptably low moisture content of the print substrate, can be avoided during the production process.

A further advantage consists in that by limiting the amount of varnish that is transferred by way of a dip volume of an anilox roller, negative effects such as wrinkling of the print substrate can be prevented.

A further advantage consists in that, by using separate drives for the anilox rollers, it can be ensured that the volume of varnish that is transferred corresponds precisely to requirements, and too much or too little varnish is not transferred. This is further promoted by the rolling contacts that exist among all the rollers.

A further advantage consists in that the coating unit, if it is embodied as separable, is more easily accessible for maintenance work and for other purposes, and, in the case of a printing couple that is separable and interacts with the coating unit, said coating unit can be separated together with said printing couple, thereby further facilitating maintenance work on the coating unit and the printing couple, for example.

A further advantage consists in that the coating unit can be embodied in various configurations, for example, with a small number of rollers, in order to decrease cost, or with a large number of rollers, including flexo printing rollers or rollers for double-sided coating, for example, in order to further increase coating quality.

Embodiment examples of the invention are illustrated in the set of drawings and will be specified in greater detail in what follows.

### BRIEF DESCRIPTION OF THE DRAWINGS

The drawings show:

FIG. 1 a schematic illustration of a print substrate and a coating unit a) or of two coating units b) as described in embodiment example 1, each containing one chamber doctor blade and one anilox roller;

FIG. 2 a schematic illustration of a print substrate and a coating unit a) or of two coating units b) as described in embodiment example 2, each containing one chamber doctor blade, one anilox roller and one impression cylinder;

FIG. 3 a schematic illustration of a print substrate and a coating unit a) or of two coating units b) as described in embodiment example 3, each containing one chamber doctor blade, one anilox roller and one forme roller;

FIG. 4 a schematic illustration of a print substrate and a coating unit a) or two coating units b) as described in embodiment example 4, each containing one chamber doctor blade, one anilox roller, one forme roller and one impression cylinder;

FIG. 5 a schematic illustration of a print substrate and a coating unit as described in embodiment example 5, containing two chamber doctor blades, two anilox rollers and two rollers, each serving as both forme roller and impression cylinder a) and b);

FIG. 6 schematic illustrations of various configurations a) and b) of a variably adjustable coating unit as described in embodiment example 6;

FIG. 7 a schematic illustration of a printing couple and a coating unit, wherein both the printing couple and the coating unit are separable, and in each case, a part of the printing couple and a part of the coating unit are rigidly connected to one another;

FIG. 8 a schematic illustration of a printing couple and a coating unit, wherein the printing couple is separable and a coating unit, which is rigidly connected to a part of the printing couple, is not separable;

FIG. 9 a schematic illustration of a variably adjustable printing couple, with which configurations similar to those or exactly the same as those of FIG. 6 can be produced.

### DESCRIPTION OF PREFERRED EMBODIMENTS

A coating unit 01 of a printing press, preferably that of a web-fed rotary offset printing press, preferably comprises at least one roller 02 embodied as an anilox roller 02, against which at least one chamber doctor blade 03 is engaged, such that the chamber doctor blade 03 forms a sealed-off volume within its interior with its sealing doctor blade, its working doctor blade, two lateral boundaries, a housing, and a part of an outer surface of the anilox roller 02. At least one infeed line and one discharge line lead to and from this volume, via which varnish can be pumped into the volume and out of the volume. At least one pump device is used for this purpose, and is preferably connected to a machine control system. During print operation, varnish is held in the volume inside the chamber doctor blade 03, and the varnish preferably fills this volume completely.

Also preferably, the infeed line, the discharge line, the chamber doctor blade 03 and the pump mechanism, along with other devices, such as a storage reservoir, for example, form a sealed-off system in which the varnish is held under a level of pressure that is greater than atmospheric pressure.

The anilox roller 02 has its own drive motor, by which it is driven and which is preferably connected to the machine control system. More particularly, the anilox roller 02 is thereby driven mechanically independently of other anilox rollers 02 or independently of other drive motors of the printing press. An outer surface of the anilox roller 02 is preferably made of a ceramic material, which can contain aluminum oxide (Al₂O₂) and/or titanium dioxide (TiO₂) and/or zirconium dioxide (ZrO₂), for example. An engraving in the form of a multitude of depressions is produced in the outer surface, preferably by means of a production process, one step of which involves a laser bombardment of the outer surface of the anilox roller 02. The depressions can be arranged, for example, in a regular punctiform structure, a linear structure, or a stochastic structure. Lines in a linear pattern of this type are also called hachures. A regular punctiform structure is a structure in which individual depressions lie on points on a uniform grid.

In the case of a linear structure, the density of the lines is 40 to 130 lines per cm. If the coating unit 01 is configured such that a print substrate 06, for example, a web of print substrate 06, rests directly on the anilox roller 02 during coating operation, the density of the lines is preferably 90 to 130 lines per cm, and more preferably 100 to 120 lines per cm. If the coating unit 01 is configured such that no print substrate 06 rests directly against the anilox roller 02 during coating operation, then the density of the lines is preferably 40 to 80 lines per cm, and more preferably 50 to 70 lines per cm. The width and depth of the individual lines, in other words, an extension along the outer surface and/or perpendicular to the outer surface of the anilox roller 02, with a predefined density of the lines, determine the total volume of varnish that the anilox roller 02 can hold in its depressions, also called its dip volume. The dip volume is based upon a desired volume of varnish to be transferred by the anilox roller 02. The dip volume of the anilox roller 02 is embodied such that, when dried, the coating film transferred to a print substrate 06 has a maximum volume per unit of surface area of 4 g/m² and preferably a maximum of 2 g/m². In other words, this means that the dip volume on a part of the outer surface of the anilox roller 02 is filled with a quantity of varnish, the mass of which, referred to this part of the outer surface of the anilox roller 02, minus a water component, averages a maximum of 4 g/m² and preferably a maximum of 2 g/m². This results in an advantageous behavior of the print substrate 06 in terms of wrinkling or in terms of the adhesion of varnished print substrates 06 to one another.

With another configuration of the depressions, for example, in a regular punctiform or stochastic structure, a defined dip volume of this type based on the application is also preferred, particularly within the above-described framework. During coating operation, the anilox roller 02 picks up varnish in that, as the anilox roller 02 rotates, the depressions come into contact with the varnish located in the interior of the chamber doctor blade 03, and are thereby filled. As the anilox roller 02 continues to rotate, excess varnish is stripped off by the working doctor blade, and only the varnish located within the depressions exits the interior of the chamber doctor blade 03. The part of the outer surface of the anilox roller 02 in which the depressions are filled with varnish then comes into contact with the print substrate 06 or with another component of the coating unit 01, which can be a roller 07 embodied as a forme roller 07, and transfers varnish to the print substrate 06 or to this other component of the coating unit 01. The varnish is preferably applied to a print substrate 06 which has already been imprinted with ink.

The ink processed by the printing press can be ink for conventional offset printing, for example, or preferably dry offset ink, and is preferably already at least partially dried before the varnish is applied. Due to the better water absorbency of print substrate 06 that has not yet come into contact with water prior to the application of varnish, the use of dry offset inks is preferred. Paper can be used as the print substrate 06, for example. In that case, uncoated and coated paper types can be used, more specifically, lighter-weight paper types that are typically used for coldset printing and have a base weight of up to 50 g/m², or more preferably, paper types customarily used for heatset printing and having a base weight greater than 40 g/m² can be used. To promote the process of the water component of the varnish penetrating into the print substrate 06, lightly coated or uncoated paper is preferred, for example, having a coat weight of less than 10 g/m². If, as is preferred, coldset inks are used, it is preferable to use paper that achieves the desired results using these inks.

The varnish contained within the volume inside the chamber doctor blade 03 is characterized by various properties. It is a dispersion varnish, in other words, a water-based varnish. More particularly, the varnish dries on the print substrate 06 primarily via penetration. That means that water and other liquid constituents that may be contained in the varnish are absorbed by the print substrate 06 and solid constituents of the varnish remain on a surface of the print substrate 06. The condition of the varnish is such that a drying process of this type occurs relatively rapidly, more specifically, rapidly enough that the varnish located on the print substrate 06 dries following its application before the varnished location on the print substrate 06 next comes into contact with another component of a printing press that comprises the coating unit 01. It is thereby ensured that ink that is covered by the varnish, and the varnish itself, can no longer be set off of the print substrate 06, and clean printed products can be produced, even with heavy ink coverage.

The coating unit 01 is disposed downstream of a printing couple 11 along a transport route of the print substrate 06, which is processed by the printing press and the coating unit 01. Preferably, when the coating unit 01 is activated, the print substrate 06 is transported through the printing press at the same speed as when the coating unit 01 is not activated, specifically at 10 to 17 m/s, and preferably at 12 to 15 m/s, without the undried varnish, once it has been applied to the print substrate 06, coming into contact with anything other than the print substrate 06 and the surrounding air. A dryer is not required for this drying process. Preferably, no dryer is disposed along the transport route for the print substrate 06 between a roller 12 of the printing couple 11 (wherein a roller 12 in this context also refers to a cylinder 12) and a roller 02; 07; 09 of the coating unit 01, which can be an anilox roller 02 or a forme roller 07. Also preferably, no dryer is disposed along the transport route of the print substrate 06 between the printing couple 11 and a folding apparatus and/or a cutting unit, and even more preferably, no dryer is provided in the printing press. Accordingly, apart from guide rollers or other devices that serve to modify the direction of the transport route, the coating unit 01 is preferably followed along the transport route of the print substrate 06 directly by a fold former or a folding apparatus, a cutting unit, or some other component of the printing press, in which and/or by which the print substrate 06 and/or inks and/or varnishes and/or constituents of these inks and/or varnishes located on or in the print substrate 06 are treated only mechanically, and in no way chemically or by the action of electromagnetic radiation or electron beams or changes in temperature. A cutting unit is also understood in this case as a perforating unit.

Additionally, apart from any guide rollers that may be present, preferably no other component of the printing press is disposed so as to touch the print substrate 06 along this transport route of the print substrate 06 between the roller 12 of the printing couple 11 and a roller 02; 07; 09 of the coating unit 01. In this manner, a print image that is to be protected against smearing by the application of varnish is prevented from becoming smeared even before the varnish is applied. For this reason, the number of guide rollers that may be present in this region is also kept as low as possible; preferably, no more than 2 guide rollers are disposed on the print substrate 06 between the roller 12 of the printing couple 11 and the roller 02; 07; 09 of the coating unit 01, and more preferably, no guide rollers at all are disposed on the print substrate 06 in this region. To be able to apply the varnish to the print substrate 06 as soon as possible after ink is applied in the printing couple 11, the smallest distance between a roller 12 of the printing couple 11 that comes into contact with the print substrate 06 and a roller 02; 07; 09 of the coating unit 01 that transfers varnish, along the transport route of the print substrate 06, is preferably less than 4 m, and more preferably less than 2 m. The varnish disposed in the interior of the chamber doctor blade 03 can be a glossy varnish, a matte varnish or a translucent varnish, for example, and it can also produce a metallic and/or a glitter effect, and/or it can be a scented varnish, which contains fragrance inside minute capsules that is released when acted upon by friction, for example.

The web-fed rotary offset printing press comprises at least one machine section, each machine section comprises at least one printing unit, and each printing unit comprises at least one printing couple 11. Preferably, each printing unit comprises four printing couples 11, which are embodied as blanket-to-blanket offset printing couples 11, in other words, particularly two forme cylinders 14 and two transfer cylinders 12 that are in contact with the forme cylinders 14 and serve as opposing impression cylinders 12.

The coating unit 01 can be configured in such a way that print substrate 06 is transported during the coating process vertically or horizontally or at an angle, in other words, with vertical and horizontal directional components. Preferably, the print substrate 06 is transported through the coating unit 01 in a direction, the vertical component of which is greater than its horizontal component, and more preferably, the print substrate 06 is transported though the coating unit 01 exclusively vertically, since advantages result in conjunction with a vertical web path in the printing couple 11 that interacts with the coating unit 01. For the preferred case, in which at least one pair consisting of two rollers 02; 07; 08; 09 each is provided, which rollers together form a coating gap, through which the print substrate 06 is transported during coating operation, these two rollers 02; 07; 08; 09 are disposed in such a way that a first plane forms an angle of less than 45°, more preferably less than 30°, and even more preferably between 1° and 20°, with a horizontal plane. In this case, the first plane is defined such that it contains a rotational axis of one of these two rollers 02; 07; 08; 09 and such that it contains a point on a rotational axis of the other of these two rollers 02; 07; 08; 09 which lies within the volume defined by the other of these two rollers 02; 07; 08; 09. It is possible to position the coating unit 01 such that after being imprinted, a print substrate 06 is fed directly to the coating unit 01. However, it is also possible for additional steps of processing the print substrate 06, such as combining multiple layers of print substrate 06 to form a print substrate strand, to be carried out between imprinting and the coating process. The coating unit 01 is preferably disposed directly on a printing unit or in a superstructure of a printing press. The coating unit 01 is preferably arranged such that at least one rotational axis of an anilox roller 09 of the coating unit 01 is disposed higher than all the rotational axes of forme cylinders 14 and other cylinders 12 and rollers 12 that are disposed in a printing unit that is situated upstream of the coating unit 01 in relation to a direction of transport of the print substrate 06.

In addition to the described components, the coating unit 01 can comprise additional components, for example, the specified, or multiple, forme rollers 07 and/or one or more rollers 08 embodied as impression cylinders 08. A series of different embodiment examples will be described in what follows. In all embodiment examples, the circumferential speed of the anilox rollers 02 and/or forme rollers 07 and/or impression cylinders 08 is preferably equal to the speed at which the print substrate 06 is transported through the printing press and particularly through the coating unit 01 during print operation. The direction of rotation of the anilox rollers 02 and/or forme rollers 07 and/or impression cylinders 08 ensures that only rolling contacts are possible between anilox rollers 02 and/or forme rollers 07 and/or impression cylinders 08 and the print substrate 06. This series of embodiment examples is not exhaustive, and other embodiments are also possible.

### Embodiment Example 1

### “Direct, with Wrap”

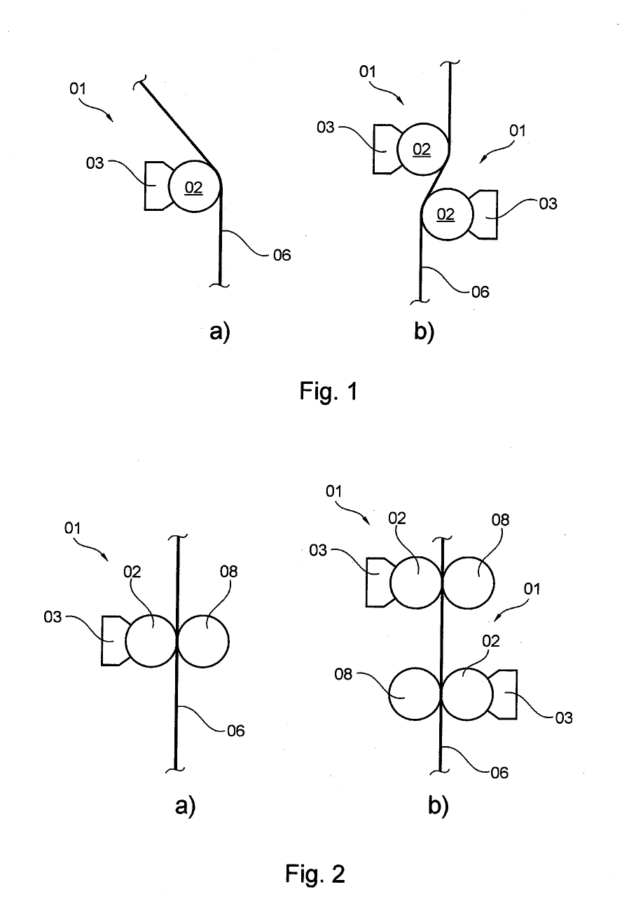

This embodiment example is also illustrated in FIG. 1 a). The web of print substrate 06 is in direct contact with the anilox roller 02 during print operation. The varnish is therefore transferred from the depressions in the outer surface of the anilox roller 02 directly onto the print substrate 06. The varnish spots transferred from the individual depressions continue to spread somewhat after they are transferred, and they become joined with one another, so that at the desired locations on the print substrate 06, a continuous varnish surface is produced. For this purpose, a relatively fine-screened anilox roller 02 is used, which means that in the case of a linear structure, the density of the lines is preferably between 90 and 130 lines per cm. The print substrate 06 is pressed by wrapping against the anilox roller 02, i.e., the print substrate 06 is in contact with the anilox roller 02 not merely along a line that extends parallel to a rotational axis of the anilox roller 02, and instead, the print substrate 06 is in contact with the anilox roller 02 along an area, in that it is guided for a certain distance along an outer surface of the anilox roller 02. The portion of the outer surface of the anilox roller 02 that is in contact with the print substrate 06 at any given time is dependent on the angle that is formed by the print substrate 06 as it is transported up to the anilox roller 02 and the print substrate 06 as it is transported away from the anilox roller 02. This angle also influences the force with which the print substrate 06 is pressed against the anilox roller 02.

It is also possible to provide two coating units 01 (FIG. 1 b)) in this embodiment, such that the one coating unit 01 coats a first side of the print substrate 06 and the other coating unit 01 coats a second side of the print substrate 06. During coating operation, the print substrate 06 is first guided with its one side along the anilox roller 02 of the one coating unit 01 and is coated with varnish, after which the other side of the print substrate 06 is guided along the anilox roller 02 of the other coating unit 01 and is coated with varnish. With each of the two contacts between an anilox roller 02 and the print substrate 06, contact pressure is produced by the wrapping of the print substrate 06 about the respective anilox roller 02, and as a result of this pressure, varnish is transferred from the depressions in the anilox roller 02 onto the print substrate 06. Because the anilox rollers 02 do not press from both sides against the same point on the print substrate 06, one point on the print substrate 06 is not coated from both sides at the same time during coating operation, and instead, between the application of the varnish on one side of the print substrate and the application of the varnish on the other side of the print substrate 06, a time difference Δt elapses, which is dependent upon the speed at which the print substrate 06 is being transported and the distance between the anilox rollers 02.

### Embodiment Example 2

### “Direct, with Counterpressure”

This embodiment example is also illustrated in FIG. 2 a). As in embodiment example 1, the print substrate 06 is coated with varnish directly by the anilox roller 02. The anilox roller 02 is embodied as in embodiment example 1, and the varnish is transferred in exactly the same way as in embodiment example 1, including the spreading of the transferred varnish spots at the desired points on the print substrate 06 to form a continuous coating surface. An impression cylinder 08 presses the print substrate 06 against the anilox roller 02 in order to achieve better contact between anilox roller 02 and print substrate 06, and thereby improve the transfer of the varnish from the depressions in the anilox roller 02 onto the print substrate 06. The print substrate 06 can wrap around the anilox roller 02 and/or the impression cylinder 08, or can be guided in a straight line between the anilox roller 02 and the impression cylinder 08, i.e., a zone of contact between print substrate 06 and anilox roller 02 can be configured as linear, parallel to the rotational axis of the anilox roller 02, or as flat on the outer surface of the anilox roller 02. The outer surface of the impression cylinder 08 is preferably made of a relatively soft material, so as to ensure that the print substrate 06 will be pressed suitably against the anilox roller 02 and to improve the transfer of the varnish to the print substrate 06. The outer surface of the impression cylinder 08 preferably has a Shore A hardness of between 30 and 70, and more preferably, the outer surface of the impression cylinder 08 has a Shore A hardness of 60. The material of the outer surface of the impression cylinder 08 can be rubber or polyurethane, for example.

It is also possible to provide two coating units 01 in this embodiment (FIG. 2 b)), so that the one coating unit 01 coats a first side of the print substrate 06 and the other coating unit 01 coats a second side of the print substrate 06. During coating operation, the print substrate 06 is first guided with its one side along the anilox roller 02 of the one coating unit 01, and is coated with varnish by way of contact pressure from an impression cylinder 08, after which the other side of the print substrate 06 is guided along the anilox roller 02 of the other coating unit 01, and is coated with varnish by way of contact pressure from an impression cylinder 08. Because the anilox rollers 02 do not press against the same point on the print substrate 06 from both sides, one point on the print substrate 06 is not coated from both sides at the same time during coating operation, and instead, between the application of the varnish on the one side of the print substrate 06 and the application of the varnish on the other side of the print substrate 06, a time difference Δt elapses, which is dependent upon the speed at which the print substrate 06 is being transported and the distance between the anilox rollers 02.

### Embodiment Example 3

### “With Forme Roller, with Wrap”

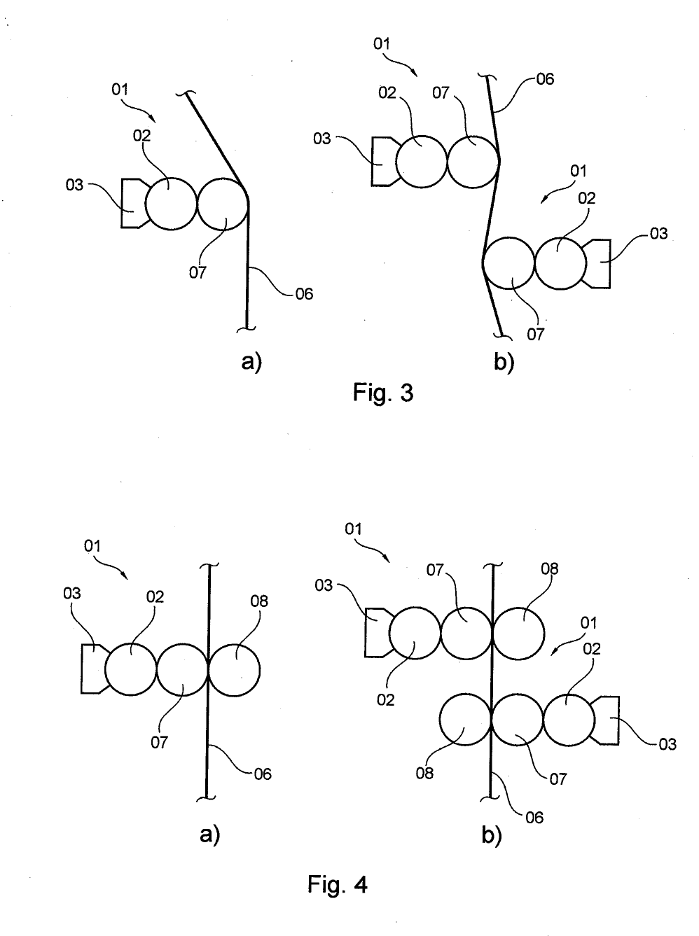

This embodiment example is also illustrated in FIG. 3 a). The anilox roller 02 is in contact with both the chamber doctor blade 03 and a forme roller 07. The forme roller 07 is in turn in rolling contact with the print substrate 06. Because the print substrate 06 is not in direct contact with the anilox roller 02, if the depressions in the outer surface of the anilox roller 02 have a linear structure, the density of the lines preferably ranges from 40 to 80 lines per cm. The print substrate 06 wraps around the forme roller 07, and therefore, the contact between forme roller 07 and print substrate 06 is embodied not as a line but as a surface, and contact pressure between print substrate 06 and forme roller 07 is produced. Varnish is transferred out of the interior of the chamber doctor blade 03 via the anilox roller 02 to the forme roller 07, and from there to the print substrate 06. The portion of an outer surface of the forme roller 07 that is in contact with the print substrate 06 at any given point in time is dependent upon the angle formed by the print substrate 06 as it is transported up to the forme roller 07 and the print substrate 06 as it is transported away from the forme roller 07. The outer surface of the forme roller 07 is preferably made of a relatively soft material, in order to ensure that the varnish will be effectively transferred out of the depressions in the anilox roller 02 that is in contact with the forme roller 07 onto the outer surface of the forme roller 07. The outer surface of the forme roller 07 preferably has a Shore A hardness of between 30 and 70, more preferably, the outer surface of the forme roller 07 has a Shore A hardness of 60. The material of the outer surface of the forme roller 07 can be rubber or polyurethane, for example. The forme roller 07 can also be embodied as a spot coating roller, so that it can be used to carry out spot coating. In that case, the forme roller 07 is dimensioned such that its circumference is equal to the circumference of a transfer cylinder 12 in a printing couple 11 of the printing press. In addition, the forme roller 07 is embodied such that only certain, specifically selectable parts of the outer surface of the forme roller 07 are able to take up varnish and therefore transfer varnish. It is thereby ensured that, on each imprinted section of the print substrate 06, for example, on each imprinted page of a printed product, the same part of the section is always coated or not coated.

It is also possible to provide two coating units 01 in this embodiment (FIG. 3b)), so that the one coating unit 01 coats a first side of the print substrate 06 and the other coating unit 01 coats a second side of the print substrate 06. During coating operation, the print substrate 06 is guided first with its one side along the forme roller 07 of the one coating unit 01 and is coated with varnish, after which the other side of the print substrate 06 is guided along the forme roller 07 of the other coating unit 01 and is coated with varnish. With each of the two contacts between a forme roller 07 and the print substrate 06, contact pressure is produced by the wrapping of the print substrate 06 around the respective forme roller 07, whereby the varnish is transferred from the forme roller 07 onto the print substrate 06. Because the forme rollers 07 do not press from both sides against the same point on the print substrate 06, one point on the print substrate 06 is not varnished from both sides at the same time during coating operation, and instead, between the application of the varnish onto the one side of the print substrate 06 and the application of the varnish onto the other side of the print substrate 06, a time difference Δt elapses, which is dependent upon the speed at which the print substrate 06 is being transported and the distance between the forme rollers 07. The forme roller 07 of one or both coating units 01 can be embodied such that it can be used to carry out spot coating.

### Embodiment example 4

### “With Forme Roller, with Counterpressure”

This embodiment example is also illustrated in FIG. 4 a). The anilox roller 02 is in contact with both the chamber doctor blade 03 and a forme roller 07. The forme roller 07 is in turn in rolling contact with the print substrate 06. Because the print substrate 06 is not in direct contact with the anilox roller 02, if the depressions in the outer surface of the anilox roller 02 have a linear structure, the density of the lines preferably ranges from 40 to 80 lines per cm. An impression cylinder 08 presses the print substrate 06 against the forme roller 07, in order to achieve better contact between forme roller 07 and print substrate 06 and thereby to improve the transfer of varnish from the forme roller 07 onto the print substrate 06. The print substrate 06 can wrap around the forme roller 07 and/or the impression cylinder 08 or can also be guided in a straight line between the forme roller 07 and the impression cylinder 08. The outer surface of the forme roller 07 is preferably made of a relatively soft material, so as to ensure that the varnish will be effectively transferred out the depressions in the anilox roller 02 that is in contact with the forme roller 07 onto the outer surface of the forme roller 07. The outer surface of the forme roller 07 preferably has a Shore A hardness of between 30 and 70, and more preferably, the outer surface of the forme roller 07 has a Shore A hardness of 60. The material of the outer surface of the forme roller 07 can be rubber or polyurethane, for example. The material of the outer surface of the impression cylinder 08 is harder than the material of the outer surface of the forme roller 07, preferably having a Shore A hardness greater than 70, and can be Rilsan, for example. The forme roller 07 can also be embodied as a spot coating roller. In that case, the forme roller 07 is dimensioned such that its circumference is equal to the circumference of a transfer cylinder in a printing couple 11 of the printing press. In addition, the forme roller 07 is configured such that only certain, deliberately selectable parts of the outer surface of the forme roller 07 are able to take up and therefore transfer varnish. It is thereby ensured that on each imprinted section of the print substrate 06, for example, on each imprinted page of a printed product, the same part of the section is always varnished or not varnished.

It is also possible to provide two coating units 01 in this embodiment (FIG. 4 b)), so that the one coating unit 01 coats a first side of the print substrate 06 and the other coating unit 01 coats a second side of the print substrate 06. During coating operation, the print substrate 06 is first guided with its one side along the forme roller 07 of the one coating unit 01 and is coated with varnish, after which the other side of the print substrate 06 is guided along the forme roller 07 of the other coating unit 01 and is coated with varnish. With each of the two contacts between a forme roller 07 and a print substrate 06, contact pressure is generated by the respective impression cylinder 08, whereby the varnish is transferred from the forme roller 07 onto the print substrate 06. In each case, the print substrate 06 can wrap around the forme roller 07 and/or the impression cylinder 08 or can also be guided in a straight line between forme roller 07 and impression cylinder 08. Because the forme rollers 07 do not press from both sides against the same point on the print substrate 06, one point on the print substrate 06 is not coated from both sides at the same time during coating operation, and instead, between the application of the varnish onto the one side of the print substrate 06 and the application of the varnish onto the other side of the print substrate, a time difference Δt elapses, which is dependent upon the speed at which the print substrate 06 is transported and the distance between the forme rollers 07. The forme roller 07 of one or both coating units 01 can be embodied such that it can be used to carry out spot coating.

### Embodiment Example 5

### “Double-Sided with Forme Roller the Same as Impression Cylinder”

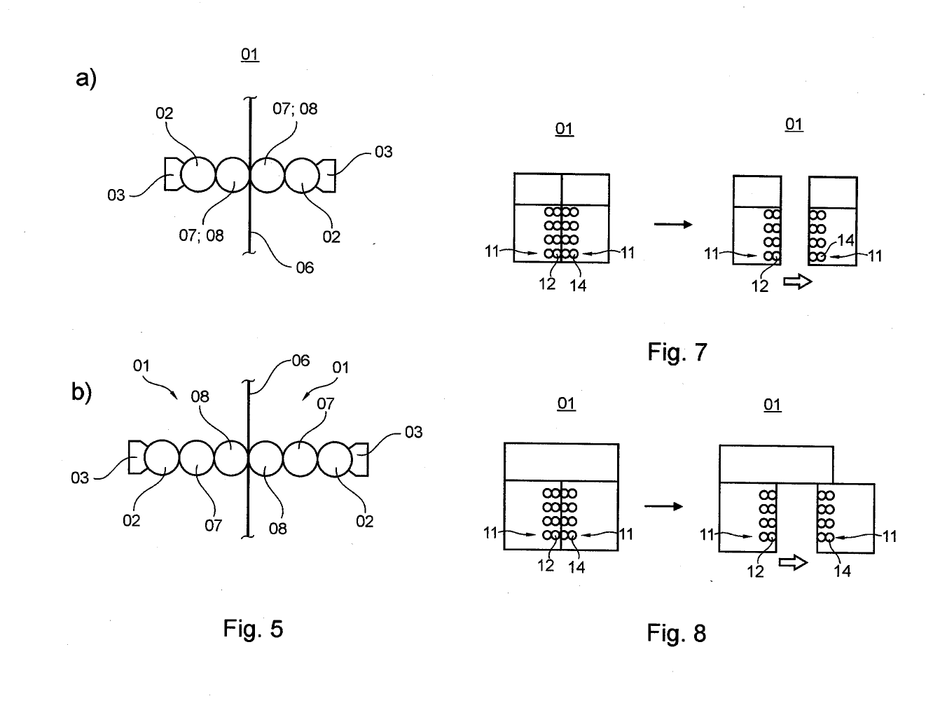

This embodiment example is also illustrated in FIG. 5 a). This embodiment example describes the preferred embodiment of the coating unit 01. The entire coating unit 01 comprises at least two chamber doctor blades 03, two anilox rollers 02 and two forme rollers 07, which also serve as impression cylinders 08. During coating operation, the print substrate 06 is in contact simultaneously with one forme roller 07 on each of its two sides, and is therefore coated with varnish on both sides simultaneously. In this case, each of the two forme rollers 07 acts as the impression cylinder 08 of the respectively other forme roller 07, in order to achieve better contact between forme roller 07 and print substrate 06, and thereby improve the transfer of varnish from the forme roller 07 onto the print substrate 06. The print substrate 06 can wrap around one or both forme rollers 07 or can also be guided in a straight line between the two forme rollers 07. In a preferred embodiment, the outer surface of each forme roller 07 is preferably made of a relatively soft material, so as to ensure that the varnish is effectively transferred out of the depressions in the anilox roller 02, which is in contact with the forme roller 07, onto the outer surface of the forme roller 07. The outer surface of the forme roller 07 preferably has a Shore A hardness of between 30 and 70, and more preferably, the outer surface of the forme roller 07 has a Shore A hardness of 60. The material of the outer surface of the forme roller 07 can be rubber or polyurethane, for example. One or both forme rollers 07 can also be embodied as a spot coating roller. In that case, the corresponding forme roller 07 is dimensioned such that its circumference is equal to the circumference of a transfer cylinder 12 in a printing couple 11 of the printing press. In addition, the forme roller 07 is configured such that only certain, deliberately selectable parts of the outer surface of the forme roller 07 are able to take up and therefore transfer varnish. It is thereby ensured that, on each imprinted section of the print substrate 06, for example, on each imprinted page of a printed product, the same part of the section is always varnished or not varnished. If the spot coating rollers are embodied as flexo printing rollers, then it is necessary to position an anilox roller 02, a forme roller 07 in contact with the former and embodied as a flexo printing roller, and a roller 08 that functions simultaneously as transfer roller and as impression cylinder 08 (FIG. 5 b)), on each side of the print substrate 06.

### Embodiment Example 6

### “Flexible Coating Unit for Producing Various Configurations”

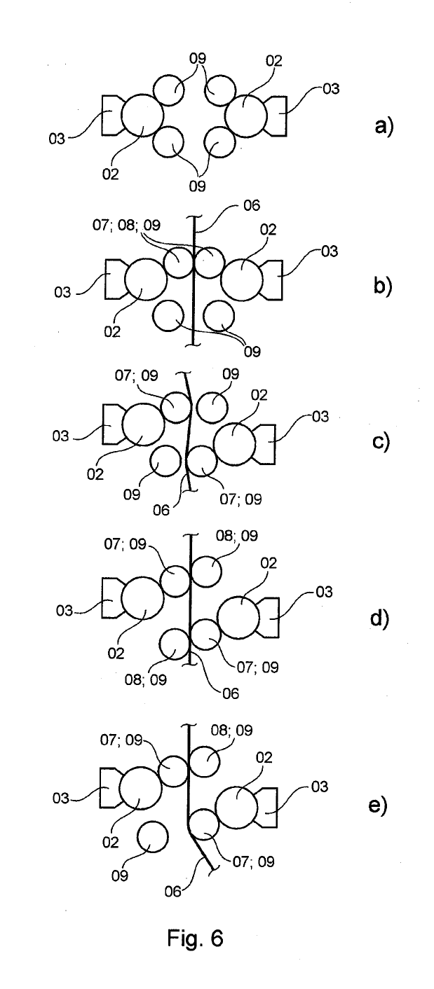

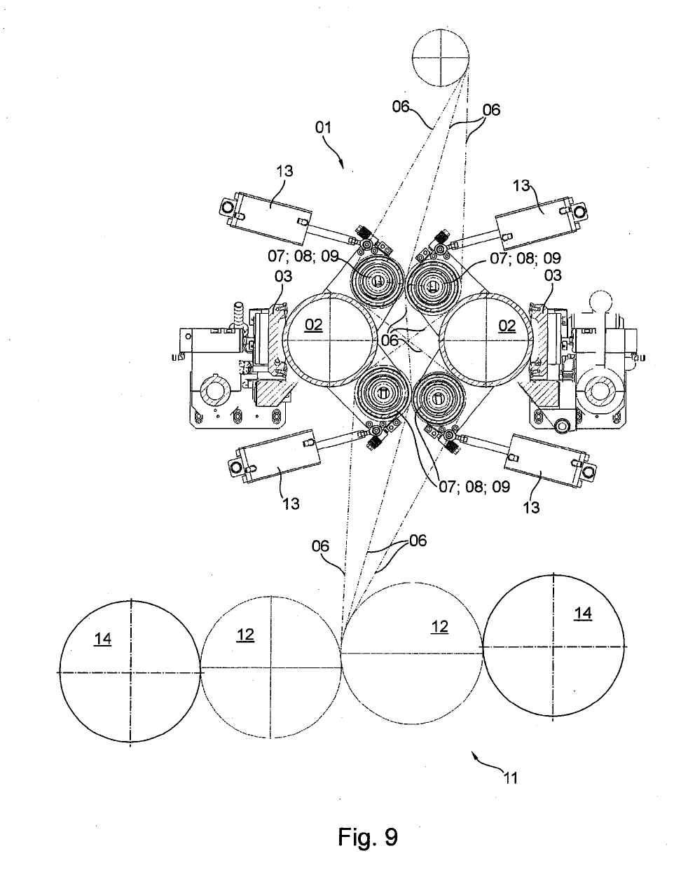

This embodiment example is also illustrated in FIGS. 6 and 9. In addition to at least two chamber doctor blades 03 and at least two anilox rollers 02, at least two, but preferably four, additional rollers 09 are also provided, which can be used as forme rollers 07 and/or as impression cylinders 08. These rollers 09 are mounted in such a way that each is displaceable perpendicular to the direction of its rotational axis, and devices for displacing these rotational axes are provided. The rollers 09 are preferably mounted such that when the rollers 09 are displaced, their rotational axes can be displaced along a virtual cylinder outer surface, the axis of symmetry of which coincides with a rotational axis of the anilox roller 02 that is adjacent to the respective roller 09. In this case, the rollers 09 are always in contact with the corresponding anilox roller 02. Moreover, devices are preferably and optionally additionally provided, with which the corresponding roller 09 can be displaced perpendicular to its rotational axis, independently of this virtual cylinder outer surface. Such devices can be of the type disclosed in DE 101 52 021 C2, for example.

During coating operation, two rollers 09 can be displaced in such a way that they are each in contact with an anilox roller 02 and such that they press together from both sides against the print substrate 06 being guided between them. Other rollers 09 play no role in this. The coating unit configuration is thereby the same as in embodiment example 5 (FIG. 6 b)).

It is also possible for the one side of the print substrate 06 to be coated by a roller 09 which is used as a forme roller 07, while the other side of the print substrate 06 is coated by another roller 09, which is also used as a forme roller 07, and for each of the two rollers 09 used as forme rollers 07 to be in contact with another anilox roller 02. In each case, the print substrate 06 wraps around the forme roller 07, so that the contact surfaces between print substrate 06 and forme roller 07 are embodied not as linear, but as flat. The two rollers 09 used as forme rollers 07 coat the print substrate 06 at different points, and do not serve mutually as impression cylinders 08. The result is a coating unit configuration as in embodiment example 3 (FIG. 6 c)). In addition, a roller 09 that is used as impression cylinder 08, which is pressed against by the respectively other side of the print substrate 06 and is not in contact with an anilox roller 02, can be assigned to one (FIG. 6 d)) or both (FIG. 6 d)) rollers 09 that are used as forme rollers 07. If an impression cylinder 08 is assigned to both forme rollers 07, the result is a coating unit configuration as shown in embodiment example 4 (FIG. 6d)). A roller 09 used in this case as impression cylinder 08 can be a roller 09 that can be used both solely as an impression cylinder 08, and as impression cylinder 08 and forme roller 07 simultaneously. It is also possible with this printing couple 01 to align all rollers 02; 07; 08; 09 in such a way that only one side of the print substrate 06 is coated.

The outer surface of each forme roller 07 described in this embodiment example preferably has a Shore A hardness of between 30 and 70, more preferably, the outer surface of forme roller 07 has a Shore A hardness of 60. The material of the outer surface of the forme roller 07 can be rubber or polyurethane, for example. Each forme roller 07 described in this embodiment example can also be embodied as a spot coating roller. In that case, the corresponding forme roller 07 is dimensioned such that its circumference is equal to the circumference of a transfer cylinder 12 in an inking unit of the printing press. Moreover, the forme roller 07 is configured such that only certain, deliberately selectable parts of the outer surface of the forme roller 07 are able to take up and therefore transfer varnish. It is thereby ensured that, on each imprinted section of the print substrate 06, for example, on each imprinted page of a printed product, the same part of the section is always coated or not coated.

The outer surface of each roller 09 used in this embodiment example exclusively as an impression cylinder 08 is preferably made of a material that repels the substance, specifically either ink or varnish, that is applied to the print substrate 06 before it comes into contact with this impression cylinder 08, in order to prevent the ink that has been applied to its side of the print substrate 06, or the varnish that has been applied to its side of the print substrate 06, from becoming smeared during the process of coating the other side of the print substrate 06.

In what follows, details of the coating unit 01 which apply equally to all embodiments will be described.

The coating unit 01 can preferably be separated, for example, for maintenance operations. In this process, at least one part of the coating unit 01 is preferably displaced, while at least one other part of the coating unit 01 is held fixed in its position or is displaced in a different direction. More preferably, separation is carried out such that those components of the coating unit 01, such as a chamber doctor blade 03, an anilox roller 02, and any forme rollers 07 and/or impression cylinders 08 and/or general rollers 09 which may be provided and which, during coating operation, are disposed touching one side of the print substrate 06 or are in connection with such components, are not displaced, whereas those components of the coating unit 01, such as a chamber doctor blade 03, an anilox roller 02 and any forme rollers 07 and/or impression cylinders 08 and/or general rollers 09 which may be provided and which, during coating operation, are disposed touching another side of the print substrate 06 or are in connection with such components, are displaced such that they are moved away from the non-displaced components of the coating unit 01. The coating unit 01 can therefore be separated, regardless of whether or not a print substrate 06 is located in the coating unit 01. Even more preferably, a part of a housing of the coating unit 01 that is not displaced is rigidly connected to a part of a housing of the printing couple 11, which also is not displaced, whereas another part of the housing of the coating unit 01 that is displaced is rigidly connected to another part of the housing of the printing couple 11, which can be displaced, for example, for maintenance operations (FIG. 7). If the coating unit 01 is not embodied as separable, its housing is preferably rigidly connected to at least one part of the housing of the printing couple 11 (FIG. 8). A rigid connection is understood as a connection between two parts which can be separated from one another in principle, for example, by loosening screws or similar connectors, but which during normal operation, and particularly in the case of running operation, cannot be moved relative to one another.

Regardless of whether the coating unit 01 is embodied as separable, all anilox rollers 02 and/or forme rollers 07 and/or impression cylinders 08 of the coating unit 01 that are in contact with an at least partially coated side of the print substrate 06 can preferably be disengaged from the print substrate 06. In the case in which a forme roller 07 and/or an impression cylinder 08 is engaged against the print substrate 06, said roller can be disengaged from the print substrate 06, for example, by a linear and/or curved, for example, arc-shaped movement, for example, about a rotational axis of an adjacent roller 09. Combinations of such movements are also possible. If an anilox roller 02 is engaged directly against the print substrate 06, the same applies to the disengaging movement thereof; however, the adjoining chamber doctor blade 03 must also be moved together with the anilox roller, preferably such that varnish does not escape in an uncontrolled fashion from the chamber doctor blade 03. The same applies to infeed and discharge lines. In any case, the disengaging movement is preferably carried out in directions exclusively perpendicular to a respective rotational axis of the roller 02; 07; 08; 09 that is in contact with the print substrate 06.

It is also possible for only a partial web to be optionally coated by the coating unit 01, i.e., only a part of the print substrate 06, referred to the direction parallel to the rotational axis of the anilox roller 02, for example, one-half, one-third, or one-fourth thereof, is coated. There are various options for implementing this. If one forme roller 07 is provided in the coating unit 01, said roller can be configured such that it is able to take up and transfer varnish only on the part of its extension, in the direction parallel to the rotational axis of the anilox roller 02, which comes into contact with the part of the print substrate 06 on which varnish is to be applied. Regardless of whether or not a forme roller 07 is provided in the coating unit 01, a chamber doctor blade 03 is preferably provided, the extension of which, referred to the direction parallel to a rotational axis of an adjoining anilox roller 02, is exactly the same size as the region of the print substrate 06 that is to be coated, in other words, optionally smaller than an extension of the print substrate 06 in the direction perpendicular to the direction of transport of the print substrate 06, said chamber doctor blade being disposed such that during coating operation, varnish is ultimately transferred only to the desired points on the print substrate 06. A modification of the extension of the forme roller 07 in the direction of its rotational axis is also conceivable for this purpose.

If an entire strand of print substrate, in other words, a plurality of layers of print substrate 06 lying one on top of the other, will be transported through the coating unit 01 in coating operation, this print substrate strand can also be coated, i.e., either one or both outer layers of the print substrate 06, depending on the coating unit configuration, will each be coated with a layer of varnish on the side thereof that faces away from the remainder of the print substrate strand. The dimensions of gaps between forme rollers 07 and anilox rollers 02 or impression cylinders 08 involved in this are to be adjusted accordingly.

If two coating units 01 are used for coating both sides of the print substrate 06, wherein varnish is applied to the print substrate 06, at a point on one side of the print substrate 06, not at precisely the same time as it is applied to a point exactly opposite thereof on the other side of the print substrate 06, then the speed at which the print substrate 06 is transported and the distance between the two points to which varnish is applied are preferably adjusted to match one another, such that the resulting time difference Δt between the application of varnish to the two stated points is less than 0.5 seconds. In other words, this means that the product of a transport speed of the print substrate 06 and a time of 0.5 seconds must be greater than the distance between the two points, at each of which one side of the print substrate 06 is in contact with a corresponding roller 02; 07; 09 for applying varnish in the coating unit 01.

Each spot coating roller can be embodied as a flexo printing roller, with the selection of the coating regions being determined by a different radius at the corresponding point. It must be taken into account that two spot coating rollers preferably should not be positioned to act opposite one another as impression cylinders 08, since different radii occurring in at least one flexo printing roller will not ensure a constant counterpressure over an outer surface of the flexo printing roller. Instead, the property of whether or not varnish will be transferred can be influenced, for example, by the selection of the surface material, for example, as is also the case with offset printing.

In another embodiment, the coating unit 01 is embodied at least partially as a contactless coating unit 01. A contactless coating unit 01 of this type can comprise, for example, at least one spray apparatus, preferably a spray bar having a plurality of spray devices in a direction perpendicular to a direction of transport of the print substrate 06 and/or parallel to the direction of transport of the print substrate 06. Spray nozzles of this type are known in the art. By means of a control mechanism or a regulating mechanism, which is preferably connected to the machine control system, the spray nozzles can be switched on and off. It is thereby possible to operate the coating unit 01 and carry out a full-surface coating only optionally. More particularly, however, it is also possible thereby to carry out spot coating, in which, for example, with each rotation of a forme cylinder 14 of a printing couple 11 imprinting the print substrate 06 that will be coated, each spray nozzle executes a specific, preferably identical spraying process, according to a desired varnish application. A spraying process of this type can consist, for each individual nozzle, in a constant spray operation, a constant shut-off, or an alternating sequence of any number of spraying operations and shut-off periods, for each spray nozzle individually. In this, the spray nozzles are switched on and off individually, on the basis of a desired coating pattern. More particularly, the processes for switching different spray nozzles on and off are independent of one another.

In all the described embodiments, the coating unit 01, together with the print substrate 06, forms a system consisting of the respective coating unit 01 and the print substrate 06 located therein.

A number of rollers 09 between chamber doctor blade 03 and print substrate 06 can also be increased if it is necessary to accordingly decrease a desired volume of varnish to be transferred.

A continuous varnished area is preferably achieved by covering an outer surface of a corresponding roller 07; 08; 09 that will transfer varnish to the print substrate 06 at least 80% and preferably at least 90% with varnish. Outer surfaces of rollers 07; 08; 09 for transferring varnish which are not anilox rollers 02 are preferably produced by providing packings, which form the outer surfaces of these rollers 07; 08; 09. A packing of this type can be embodied, for example, as a printing blanket, in other words, as layered, dimensionally stable carrier plates, which can have multiple layers, for example, one layer made of a metal and forming a base, and one layer made of an elastomer of appropriate hardness. A packing of this type can be mounted or is mounted on the corresponding cylinder 07; 08; 09, and can be secured or is secured in appropriate grooves in the rollers 07; 08; 09.

More preferably, a packing can be disposed or is disposed on at least one roller (07; 08; 09) of the coating unit (01), which packing has the same sequence of layers as at least one packing that is disposed in at least one printing couple that will process the same print substrate (06). Components that are used can thereby be standardized, resulting in lower administrative and operating costs.

While preferred embodiments of methods for using a web-fed rotary offset printing press, and a web-fed rotary offset printing press having at least one coating unit and at least one printing couple, in accordance with the present invention, have been set forth fully and completely hereinabove, it will be apparent to one of skill in the art that various changes in, for example, the specific structure and drives for the printing couples, the web transport assembly and the line couple be made without departing from the spirit and scope of the subject application which is accordingly to be limited only by the appended claims.

1.-50. (canceled)

51. A method for using a web-fed rotary offset printing press having at least one coating unit (01) and at least one printing couple (11), wherein the coating unit (01) comprises at least one chamber doctor blade (03) containing a water-based varnish, and at least one anilox roller (02), wherein at least one anilox roller (02) has a plurality of depressions in its outer surface that together form a dip volume, and wherein the coating unit (01) is disposed downstream of the at least one printing couple (11) of the web-fed rotary offset printing press along a transport route of a print substrate (06), which is processed by the web-fed rotary offset printing press and by the coating unit (01), and wherein at least one pair of two rollers each (02; 07; 08; 09) is provided, which together form a coating gap, characterized in that these two rollers (02; 07; 08; 09), which together form a pair, are each disposed in such a way that a plane, which contains a rotational axis of one of these two rollers (02; 07; 08; 09) and which contains a point on a rotational axis of the other of the two rollers (02; 07; 08; 09), disposed within a volume defined by this other of these two rollers (02; 07; 08; 09), forms an angle of less than 45° with a horizontal plane, and in that in each case, at least one roller (07; 08; 09) of at least one such pair is in contact with the at least one anilox roller (02), and in that the dip volume, at least over a part of the outer surface of the at least one anilox roller (02), is filled with a volume of varnish, the mass of which, referred to this part of the outer surface of the at least one anilox roller (02), minus a water component, is an average of at most 4 g/m², and in that a packing having a plurality of layers can be mounted or is mounted on at least one roller (07; 08; 09) of the coating unit (01).

52. A web-fed rotary offset printing press having at least one coating unit (01) and at
least one printing couple (11), wherein the coating unit (01) comprises at least one chamber doctor blade (03) and at least one anilox roller (02), wherein at least one anilox roller (02) has a plurality of depressions in its outer surface, which together form a dip volume, and wherein the coating unit (01) is disposed downstream of the at least one printing couple (11) of the web-fed rotary offset printing press, along a transport route of a print substrate (06), which is processed by the web-fed rotary offset printing press and by the coating unit (01), characterized in that at least one rotational axis of an anilox roller (09) of the coating unit (01) is positioned higher than all the rotational axes of forme cylinders (14) and other cylinders (12) and rollers (12) which are disposed in a printing unit situated upstream of the coating unit (01) in a direction of transport of the print substrate (06), and in that the at least one printing couple (11) is separable, and one part of a housing of the at least one printing couple (11) is disposed so as to be displaceable and one part of the housing of the at least one printing couple (11) is disposed so as to be non-displaceable, and in that the at least one coating unit (01) is not separable, and in that a housing of the at least one coating unit (01) is rigidly connected to one of the parts of the housing of the at least one printing couple (11).

53. The method for using a web-fed rotary offset printing press according to claim 52, characterized in that the dip volume is filled at least over a part of the outer surface of the anilox roller (02) with a volume of varnish, the mass of which, referred to that part of the outer surface of the anilox roller (02), minus a water component, is an average of at most 4 g/m².

54. The web-fed rotary offset printing press according to claim 52, characterized in that at least one pair of two rollers (02; 07; 08; 09) each, which together form a coating gap, is provided, and in that these two rollers (02; 07; 08; 09), which together form a pair, are each disposed in such a way that a plane, which contains a rotational axis of one of these two rollers (02; 07; 08; 09) and which contains a point on a rotational axis of the other of the two rollers (02; 07; 08; 09), disposed within a volume defined by this other of these two rollers (02; 07; 08; 09), forms an angle of less than 45° with a horizontal plane.

55. The web-fed rotary offset printing press according to claim 52, characterized in that at least one pair of two rollers (02; 07; 08; 09) each, which together form a coating gap, is provided, and in that in each case, at least one roller (07; 08; 09) of at least one such pair is in contact with the at least one anilox roller (02).

56. The web-fed rotary offset printing press according to claim 52, characterized in that a packing having a plurality of layers can be mounted or is mounted on at least one roller (07; 08; 09) of the coating unit (01).

57. The web-fed rotary offset printing press according to claim 52, characterized in that downstream of the coating unit (01) along the transport route of the print substrate (06), apart from guide rollers or other devices for modifying the direction of transport of the print substrate (06), a folding apparatus and/or a cutting unit is provided as the next device that will act on the print substrate (06).

58. The web-fed rotary offset printing press according to claim 51, characterized in that at least one rotational axis of an anilox roller (09) of the coating unit (01) is positioned higher than all the rotational axes of forme cylinders (14) and other cylinders (12) and rollers (12) which are disposed in a printing unit situated upstream of the coating unit (01) in a direction of transport of the print substrate (06).

59. The method according to claim 51, characterized in that the web-fed rotary offset printing press is embodied as a printing press that processes dry offset inks.

60. The web-fed rotary offset printing press according to claim 52, characterized in that all the rollers (02; 07; 08; 09) of the coating unit (01), which during coating operation are arranged touching one side of the print substrate (06) or are disposed in contact with such rollers (02; 07; 08; 09) that are touching said one side of the print substrate (06), are arranged so as to be movable in a manner that will distance them from rollers (02; 07; 08; 09) of the coating unit (01), which during coating operation are arranged touching another side of the print substrate (06), or are disposed in contact with such rollers (02; 07; 08; 09) that are touching said other side of the print substrate (06).

61. The method according to claim 51, characterized in that the dip volume, at least over a part of the outer surface of the anilox roller (02), is filled with a volume of varnish, the mass of which, referred to this part of the outer surface of the anilox roller (02), minus a water component, is an average of at most 2 g/m².

62. The web-fed rotary offset printing press according to claim 52, characterized in that at least one anilox roller (02) has its own drive motor.

63. The web-fed rotary offset printing press according to claim 52, characterized in that as components of the printing press that are in contact with the print substrate (06), only devices for modifying the direction of transport of the print
substrate (06) are arranged along the transport route of the print substrate (06) between a roller (12) of the printing couple (11) and a roller (02; 07; 09) for transferring varnish in the coating unit (01).

64. The web-fed rotary offset printing press according to claim 52, characterized in that as components of the printing press that are in contact with the print substrate (06), only guide rollers are arranged along the transport route of the print substrate (06) between a roller (12) of the printing couple (11) and a roller (02; 07; 09) for transferring varnish in the coating unit (01).

65. The web-fed rotary offset printing press according to claim 52, characterized in that the number of guide rollers that are in contact with the print substrate (06) along the transport route of the print substrate (06), between a roller (12) of the printing couple (11) and a roller (02; 07; 09) for transferring varnish in the coating unit (01), is no more than 2.

66. The web-fed rotary offset printing press according to claim 52, characterized in that no components of the printing press that are in contact with the print substrate (06) are arranged along the transport route of the print substrate (06) between a roller (12) of the printing couple (11) and a roller (02; 07; 09) for transferring varnish in the coating unit (01).

67. The web-fed rotary offset printing press according to claim 52, characterized in that the print substrate (06) to be coated is in direct contact with the anilox roller (02), and the print substrate (06) is disposed touching the surface of the anilox roller (02).

68. The web-fed rotary offset printing press according to claim 52, characterized in that the print substrate (06) to be coated is in direct contact with the anilox roller
(02), and an impression cylinder (08) is provided, which presses the print substrate (06) against the anilox roller (02).

69. The web-fed rotary offset printing press according to claim 52, characterized in that the print substrate (06) to be coated is in contact with a forme roller (07), which is in contact with the anilox roller (02), and the print substrate (06) is disposed touching the surface of the forme roller (07).

70. The web-fed rotary offset printing press according to claim 52, characterized in that the print substrate (06) to be coated is in contact with a forme roller (07), which is in contact with the anilox roller (02), and an impression cylinder (08) is provided, which presses the print substrate (06) against the forme roller (07).

71. The web-fed rotary offset printing press according to claim 70, characterized in that this coating unit (01) is in contact with a point on a first side of the print substrate (06), and is disposed so as to coat said point, and in that the print substrate (06) is in coating contact with another coating unit (01) on a second side of the print substrate (06), wherein the two points at which the print substrate (06) is in coating contact with a coating unit (01) are spaced from one another, and wherein in the other coating unit (01)
either the print substrate (06) to be coated is in direct contact with an anilox roller (02) and the print substrate (06) is disposed touching the surface of this anilox roller (02),
or the print substrate (06) to be coated is in direct contact with an anilox roller (02) and an impression cylinder (08) is provided, which presses the print substrate (06) against this anilox roller (02),
or the print substrate (06) to be coated is in contact with a forme roller (07),
which is in contact with an anilox roller (02), and the print substrate (06) is disposed touching the surface of this forme roller (07),
or the print substrate (06) to be coated is in contact with a forme roller (07), which is in contact with an anilox roller (02), and an impression cylinder (08) is provided, which presses the print substrate (06) against this forme roller (07).

72. The web-fed rotary offset printing press according to claim 52, characterized in that at least two chamber doctor blades (03), two anilox rollers (02) and two forme rollers (07), which are pressed against one another, and which press from two sides against the print substrate (06) disposed between them, are provided.

73. The web-fed rotary offset printing press according to claim 72, characterized in that an outer surface of at least one forme roller (07) is made of a material having a Shore A hardness of 30 to 70.

74. The web-fed rotary offset printing press according to claim 68, characterized in that the outer surface of at least one impression cylinder (08) is made of a material having a Shore A hardness of 30 to 70.

75. The web-fed rotary offset printing press according to claim 70, characterized in that the outer surface of the impression cylinder (08) is made of a material having a Shore A hardness greater than 70.

76. The web-fed rotary offset printing press according to claim 52, characterized in that at least two chamber doctor blades (03), two anilox rollers (02) and at least two additional rollers (09), which can be used as forme rollers (07) and/or as impression cylinders (08), are provided, wherein the rollers (09) are disposed so as to be displaceable, perpendicular to the direction of their respective rotational axes.

77. The web-fed rotary offset printing press according to claim 76, characterized in that the chamber doctor blades (03), the anilox rollers (02), and/or the rollers (09) are disposed so as to be displaceable, and can be positioned on one and/or on both sides of the print substrate (06) to be coated, forming at least one of the following configurations:
the print substrate (06) to be coated is in contact with a forme roller (07), which is in contact with an anilox roller (02), and the print substrate (06) is disposed touching the surface of this forme roller (07),
or the print substrate (06) to be coated is in contact with a forme roller (07), which is in contact with an anilox roller (02), and an impression cylinder (08) is provided, which presses the print substrate (06) against this forme roller (07),
or the print substrate (06) to be coated is in direct contact with an anilox roller (02) and an impression cylinder (08) is provided, which presses the print substrate (06) against this anilox roller (02),
or two forme rollers (07) are provided, which are pressed against one another, and which press from both sides against the print substrate (06) disposed between them and act mutually as impression cylinders (08).

78. The web-fed rotary offset printing press according to claim 52, characterized in that at least one roller (07; 09), which during coating operation transfers varnish onto the print substrate (06), is embodied as a spot coating roller, which transfers varnish to only certain points on the print substrate (06).

79. The web-fed rotary offset printing press according to claim 78, characterized in that the spot coating roller is in direct contact with an anilox roller (02).

80. The web-fed rotary offset printing press according to claim 78, characterized in that the spot coating roller is embodied as a flexo printing roller.

81. The method according to claim 51, characterized in that an extension of at least one chamber doctor blade (03) in a direction parallel to the rotational axis of an adjacent anilox roller (02) is smaller than an extension of the print substrate (06) in the same direction.

82. The web-fed rotary offset printing press according to claim 67, characterized in that an engraving of the anilox roller (02) has a linear structure, and in that the density of lines is 90 to 130 lines per cm.

83. The web-fed rotary offset printing press according to claim 52, characterized in that an engraving of the anilox roller (02) has a linear structure and in that the density of lines is 40 to 80 lines per cm.

84. The web-fed rotary offset printing press according to claim 52, characterized in that a material of the outer surface of at least one anilox roller (02) is a ceramic material.

85. The web-fed rotary offset printing press according to claim 84, characterized in that the ceramic material contains at least aluminum oxide (Al₂O₂) and/or titanium dioxide (TiO₂) and/or zirconium dioxide (ZrO₂).

86. The method according to claim 51, characterized in that the varnish contained in the chamber doctor blade (03) is a glossy varnish, a matte varnish or a translucent varnish.

87. The method according to claim 51, characterized in that the varnish contained in the chamber doctor blade (03) is a varnish having a metallic effect and/or a varnish having a glitter effect and/or a scented varnish.

88. The web-fed rotary offset printing press according to claim 52, characterized in that all contacts occurring between involved rollers (02; 07; 08; 09; 12) and/or transfer cylinders (12) and/or the print substrate (06) are rolling contacts.

89. The method for using a web-fed rotary offset printing press according to claim 51, characterized in that the product of a transport speed of the print substrate (06) and a time of 0.5 seconds is greater than the distance between two points, at each of which one side of the print substrate (06) is in contact with a corresponding roller (02; 07; 09) for transferring varnish in the coating unit (01).

90. The method according to claim 51, characterized in that the print substrate (06) is transported through the coating unit (01) in a direction, the vertical component of which is greater than the horizontal component thereof.

91. The method according to claim 51, characterized in that a speed at which the print substrate (06) is transported through the coating unit (01) during coating operation is between 10 m/s and 17 m/s.

92. The method according to claim 51, characterized in that the web-fed rotary offset printing press is embodied as a printing press for processing coldset inks.

93. The web-fed rotary offset printing press according to claim 52, characterized in that no dryer is disposed anywhere along the transport path of the print substrate (06).

94. The web-fed rotary offset printing press according to claim 52, characterized in that all anilox rollers (02) and/or forme rollers (07) and/or impression cylinders (08) of the coating unit (01) that are in contact with an at least partially coated side of the print substrate (06) are disposed so as to be disengageable from the print substrate (06).

95. The web-fed rotary offset printing press according to claim 56, characterized in that at least one packing can be disposed or is disposed in the coating unit (01), and has the same sequence of layers as at least one packing disposed in at least one printing couple that processes the same print substrate (06).

96. The web-fed rotary offset printing press according to claim 56, characterized in that at least one layer of the packing is made of a metal or an alloy, and in that at least one other layer is made of an elastomer.

97. The method for using a web-fed rotary offset printing press according to claim 52, characterized in that the chamber doctor blade (03) contains a water-based varnish.
